(19) United States
(12) Patent Application Publication
(10) Pub. No.: US 2003/0088398 A1
(43) Pub. Date: May 8, 2003

(54) User interface of a keypad entry system for korean text input

(76) Inventors: Jin Guo, Sunnyvale, CA (US); Ali Ebrahimi, Half Moon Bay, CA (US); Jaehwa Park, Newark, CA (US)

Correspondence Address: MOTOROLA INC, 600 NORTH US HIGHWAY 45, LIBERTYVILLE, IL, 60048-5343, US

(21) Appl. No.: 10/005,718

(22) Filed: Nov. 8, 2001

(51) Int. Cl. G06F 17/20

(52) U.S. Cl. 704/8

(57) ABSTRACT

The present invention is directed to data entry keys (128) of a keypad entry system for entry of Korean text to a portable electronic device (100). The data entry keys include ten or more keys arranged in an ordered array in which each key being associated with a numeric digit (keys “1” through “9” and “0”), a phonetic consonant (302 through 328) and a phonetic vowel (402 through 420). Preferably, the phonetic consonants and the phonetic vowels are Korean Jamos symbols used to generate Korean Hangul characters. All keys of the data entry keys include a non-aspiration consonant (330), and four keys of the data entry keys include an aspiration consonant (332) in addition to the non-aspiration consonant. The non-aspiration and aspiration consonants are grouped based on similarity in pronunciation.

### FIELD OF THE INVENTION

The present invention relates to the field of keypad entry systems that provide convenient processes for ideographic character input, particularly for Asian languages. More particularly, the present invention relates to a system having phonetic symbols assigned to keys of a keypad in a novel and convenient manner for input of Korean characters.

### BACKGROUND OF THE INVENTION

Developers of portable electronic devices have struggled with designing user interfaces for data entry of ideographic characters. Asian languages, such as Chinese, Japanese and Korean, commonly use many different ideographic characters. On the other hand, portable electronic devices, such as a radiotelephone, typically have only twelve to twenty-four keys of which ten keys are used for entering numbers “1” through “9” and “0”. Accordingly, it is quite challenging to design a portable electronic device that permits a user to input the numerous characters of an Asian language using the limited quantity of keys of a standard keypad.

Keypad entry systems for the Korean language are complex. Sentences are formed as a string of Korean characters known as Hangul characters. There are about 2,350 standard Hangul characters in the Korean language, and more than 11,000 Hangul characters are theoretically possible. Each Hangul character is formed by smaller Korean phonetic symbols known as Jamo symbols. The Korean language includes twenty-four simple Jamo symbols in which fourteen are consonants and ten are vowels. To form an alphabet of thirty-three extended Jamo symbols, five double consonants and four compound vowels may be added to the above simple Jamo symbols. To form an alphabet of fifty-one compound Jamo symbols, eleven compound consonants and seven compound vowels may be added to above alphabet of extended Jamo symbols. Although other Korean compound consonants and vowels exist, they are rarely used and ignored in most Korean character input systems.

Korean keypad entry systems have been adapted for the smaller dimensions of portable electronic device keypads. For example, the “sky-people-land” decomposition is a variation that may be applied to the ten vowels of the simple Jamo symbols, four compound vowels of the extended Jamo symbols, and seven compound vowels of the compound Jamo symbols. Specifically, these twenty-one commonly used vowels are decomposed into three phonetic primitives that are denoted as “|”, “. ” and “-” and culturally regarded as “sky”, “people” and “land”. Each vowel corresponds to a particular key combination of these three phonetic primitives and, thus, all twenty-one of these vowels may be entered into a portable electronic device using only these three keys. However, the “sky-people-land” decomposition is applied only to vowels, not consonants.

Some keypad entry systems have been adapted by using multitap or predictive text entry. Each key of the keypad has more than one symbol identified on its surface for both types of text entry. For multitap text entry, a user presses a key once for entry of the key's first symbol, twice for entry of the key's second symbol, etc. For predictive text entry, the user presses a key once for each symbol and the system predicts the character that is being entered by the user. Predictive text entry is preferred because it requires, on average, less key presses for entry of each symbol.

U.S. Pat. No. 5,945,928 to C. A. Kushler, et al. titled “Reduced Keyboard Disambiguating System For the Korean Language”, granted Aug. 31, 1999, describes a keypad layout in which the majority of keys share a consonant and a vowel. However, U.S. Pat. No. 5,945,928 also requires the keypad layout to position the fourteen consonants of the simple Jamo symbols in their standard alphabetical order, and the ten vowels of the simple Jamo symbols in their standard alphabetical order. Accordingly, the various keypad orientations described by U.S. Pat. No. 5,945,928 show some keys have more than one consonant with no vowels and a single consonant with more than one vowel. This uneven distribution of symbols still leads to an inefficient method for text entry.

There is a need for an improved keypad for stroke-based ideographic text entry in which each key has a clear and reasonably unambiguous stroke meaning while being capable of addressing the numerous characters of the Korean language. In particular, there is a need for a keypad entry system for Korean text input that evenly distributes consonants and vowels throughout the keypad in a logical, sensible configuration.

### SUMMARY OF THE INVENTION

The present invention is a user interface, specifically data entry keys, of a keypad entry system for entry of Korean text to a portable electronic device. The data entry keys include ten or more keys arranged in an ordered array in which each key being associated with a numeric digit, a phonetic consonant and a phonetic vowel. Preferably, the phonetic consonants and the phonetic vowels are Korean Jamos symbols used to generate Korean Hangul characters. All keys of the data entry keys include a non-aspiration consonant, and four keys of the data entry keys include an aspiration consonant in addition to the non-aspiration consonant. For the four keys having both non-aspiration and aspiration consonants, the non-aspiration and aspiration consonants are grouped based on similarity in pronunciation. In particular, a first key is associated with the KIYEOK consonant and the KHIEUKH consonant, a second key is associated with the TIKEUT consonant and the THIEUTH consonant, a third key is associated with the PIEUP consonant and the PHIEUPH consonant, and a fourth key is associated with the CIEUC consonant and the CHIEUCH consonant.

The present invention is also a portable communication device including a plurality of keys, a controller coupled to the plurality of keys and a display coupled to the controller. The plurality of keys is arranged in an ordered array in which each key is associated with a phonetic consonant and a phonetic vowel. The controller is capable of detecting a first selection of the plurality of keys and associating the first selection to a particular phonetic consonant of the selected key. The controller is also capable of detecting a second selection, subsequent to the first selection, and associating the second selection to a particular phonetic vowel. The display is capable of displaying the particular phonetic consonant and the particular phonetic vowel.

### BRIEF DESCRIPTION OF THE DRAWINGS

FIG. 1 is a front plan view of an exemplary portable electronic device that may be adapted to operate in accordance with the embodiments of the present invention.

FIG. 2 is a block diagram of the portable electronic device of FIG. 1 in communication with a remote transceiver.

FIG. 3 is a table of the fourteen consonants of the simple Jamos symbols of the Korean language.

FIG. 4 is a table of the ten vowels of the simple Jamos symbols of the Korean language.

FIG. 5 is a diagrammatic view of a preferred keypad layout of the portable electronic device of FIG. 1.

FIG. 6 is a diagrammatic view of a first alternative keypad layout of the portable electronic device of FIG. 1.

FIG. 7 is a diagrammatic view of a second alternative keypad layout of the portable electronic device of FIG. 1.

### DETAILED DESCRIPTION OF THE PREFERRED EMBODIMENT(S)

The present invention is a user interface, specifically data entry keys, of a portable electronic device that provides for data entry of ideographic characters, particularly characters of Asian languages. The preferred embodiment, as shown in the drawings and described herein, is directed to a radiotelephone for wireless communication of voice and/or data signals and provides for data entry of Korean characters. However, it is to be understood that the present invention may be used for any type of portable electronic device such as, but not limited to, a radiotelephone, paging device, computing device, handheld device, personal digital assistant, and the like. Although the present invention is particularly useful for Asian languages, such as Korean, it may also be used for other languages of the world that utilize ideographic characters that are formed from phonetic symbols.

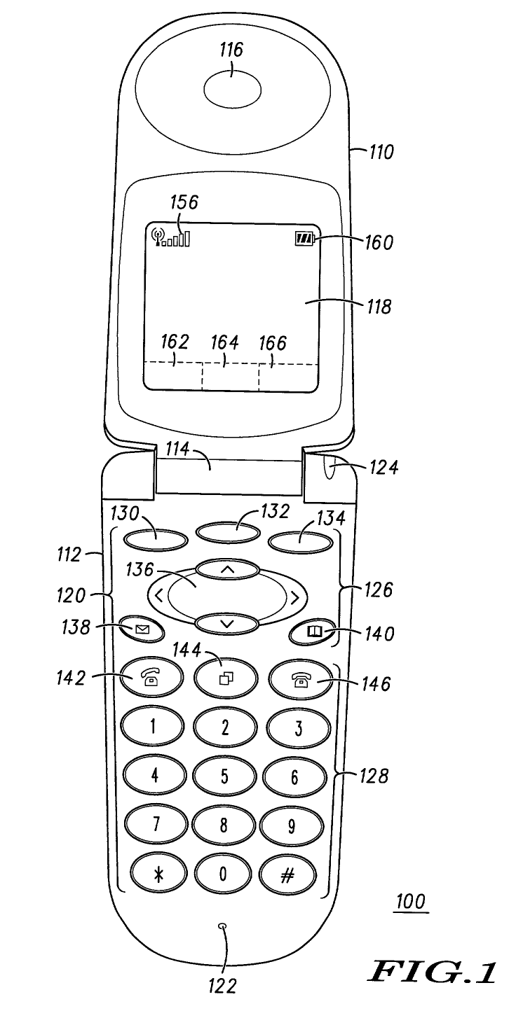

Referring to FIG. 1, the preferred embodiment 100 is a foldable, portable electronic device having a top section 110 and a bottom section 112 movably joined to one end 114 of the top section. The top section 110 includes an earpiece aperture 116 and a display 118, the bottom section 112 includes a user interface 120, a microphone aperture 122, and a visual indicator 124. The preferred embodiment 100 also includes other components of a radiotelephone (not shown) that are generally known in the art, such as an antenna, battery pack, external connectors, additional controls, and the like.

The user interface 120 of the present invention includes function keys 126 and data entry keys 128. For the preferred embodiment 100 shown in FIG. 1, the function keys 126 are located at an upper portion of the bottom section and include menu selection keys 130, 132, 134, directional keys 136 (i.e., up, down, left and right), a message retrieval key 138, a memory key 140, a call answer key 142, a clear function key 144, and a call termination key 146. The function keys 126 of the present invention are not limited to those provided for the preferred embodiment 100 and may include other programmed or user-programmable control buttons such as volume control keys, voice recording keys, device setup controls, and the like.

The data entry keys 128 of the preferred embodiment 100 are located at a lower portion of the bottom section and include ten numeric keys, namely keys “1” through “9” and “0”, as well as a “*” key and a “#” key for a total of 12 keys. As shown in FIG. 1, the data entry keys comprise a matrix of four rows in which each row includes three keys, similar to a typical telephone keypad. The data entry keys 128 of the present invention are also used to input individual Jamos symbols and as well as numbers. Thus, each key is used to input either a number or a Jamos symbol, depending upon the input mode of the device. The input mode of the device may be determined by selection of one or more function keys. For example, a user may toggle between a number input mode and a character stroke input mode by pressing a particular menu selection key 130, 132, 134.

The display 118 of the device provides various types of information to the user. Certain indicators are provided for general operation of the device, such as the signal strength indicator 156 and power indicator 160 of the preferred embodiment 100. Other indicators are provided for operation of the menu selection keys 130, 132, 134 of the function keys. For example, as shown by the preferred embodiment 100 in FIG. 1, there are three menu selection keys 130, 132, 134 provided at the top of the upper portion of the bottom section 112. Also, a bottom area of the display 118 is reserved for one to three menu selection indicators 162, 164, 166 that correspond to one or more of the menu selection keys 130, 132, 134.

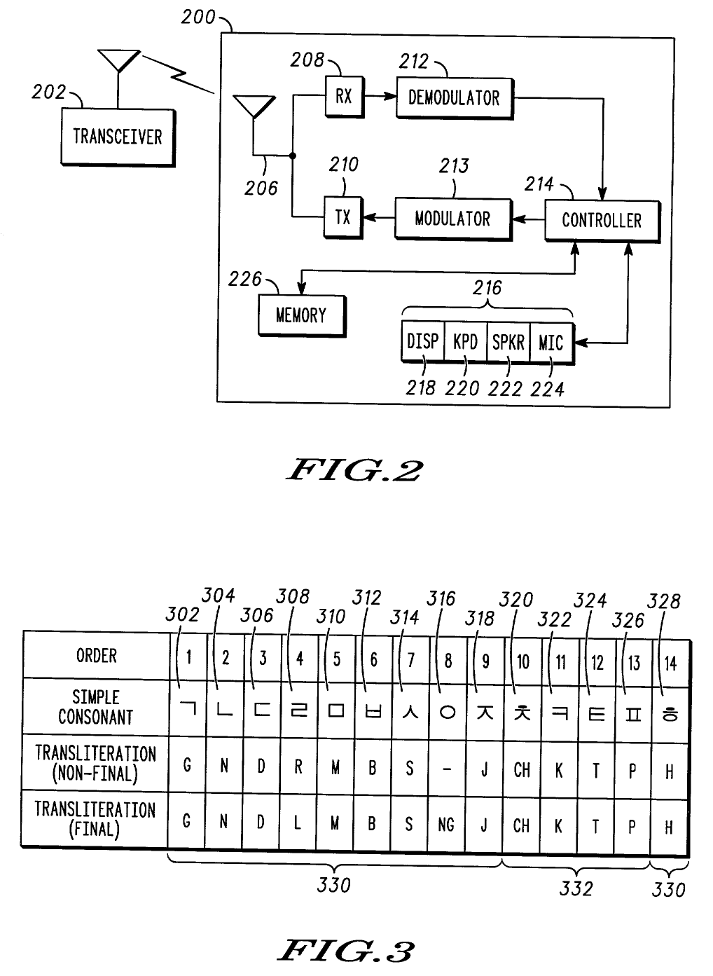

Referring to FIG. 2, there is shown a block diagram of the preferred embodiment 100, in the form of a radiotelephone 200, in communication with a remote transceiver 202. The radiotelephone 200 includes an antenna 206, a receiver 208, a transmitter 210, a demodulator 212, a modulator 213, a controller 214 and a user interface 216. Upon reception of RF signals, the radiotelephone 200 detects the RF signals through the antenna 206 producing detected RF signals. The receiver 208, coupled to the antenna 206, converts the detected RF signals into electrical baseband signals. The demodulator 212 demodulates the electrical baseband signals and recovers the data transmitted on the RF signals and outputs the data to the controller 214. The controller 214 formats the data into recognizable voice or information for use by user interface 216. The user interface 216 communicates the received information or voice to a user. Typically, the user interface 216 includes a display 218, a keypad 220, a speaker 222 and a microphone 224.

The radiotelephone 200 further includes a memory 226 for storing and retrieving data, such as Jamos symbols and Hangul characters. The controller 214 may perform various operations to store, manipulate and retrieve information in the memory 226. For example, the controller 214 may search the memory 226 for previously stored data by entering search elements or symbols from the keypad 220. During search, the controller 214 compares stored data with the input search elements or symbols. If a match is found, the matched data are displayed on the display 218.

Upon transmission of radio frequency signals from the radiotelephone 200 to the remote transceiver 202, the user interface 216 transmits user input data to the controller 214. The controller 214 typically includes a microprocessor, memory, clock generator and a power amplifier control circuit (not shown). The controller 214 formats the information obtained from the user interface 216 and conveys it to the modulator 213 for modulation of a carrier and then to the transmitter 210 for conversion into RF modulated signals. The transmitter 210 conveys the RF modulated signals to the antenna 206 for transmission to the remote transceiver 202.

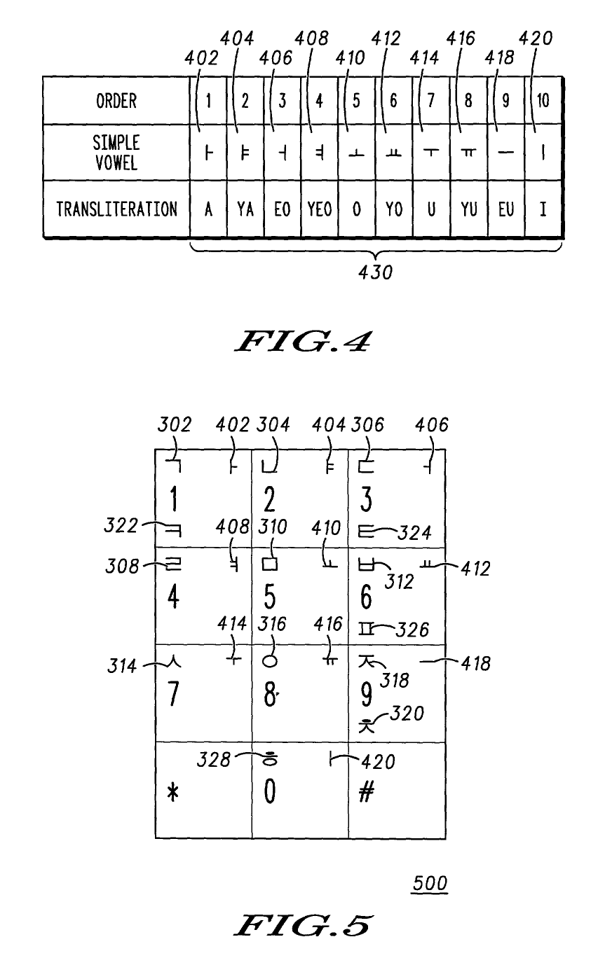

Referring to FIGS. 3 and 4, the twenty-four simple Jamos symbols of the Korean language include the fourteen consonants and the ten vowels. These twenty-four simple Jamos symbols are the most commonly used Jamos symbols of the Korean language. The fourteen consonants 330, 332 are shown in FIG. 3, as represented by the “Order” numbers, in the following alphabetical order: KIYEOK 302, NIEUN 304, TIKEUT 306, RIEUL 308, MIEUM 310, PIEUP 312, SIOS 314, IEUNG 316, CIEUC 318, CHIEUCH 320, KHIEUKH 322, THIEUTH 324, PHIEUPH 326 and HIEUH 328. Likewise, the ten vowels 430 are shown in FIG. 4, as represented by the “Order” numbers, in the following alphabetical order: A 402, YA 404, EO 406, YEO 408, O 410, YO 412, U 414, YU 416, EU 418 and I 420. Ten consonants, namely KIYEOK 302, NIEUN 304, TIKEUT 306, RIEUL 308, MIEUM 310, PIEUP 312, SIOS 314, IEUNG 316, CIEUC 318 and HIEUH 328, are non-aspiration consonants 330, whereas the other four consonants, namely CHIEUCH 320, KHIEUKH 322, THIEUTH 324 and PHIEUPH 326, are aspiration consonants 332. An aspiration consonant 332 differs from a non-aspiration consonant 330 in that an aspiration consonant requires an articulation of a speech sound accompanied by an audible puff of breath. Relative to speaking a non-aspiration consonant 330, an aspiration consonant 332 requires a user to speak with more emphasis or articulation.

The four aspiration consonants 320, 322, 324, 326 match-up with four of the non-aspiration consonants 318, 302, 306, 312, respectively, due to their similarity in pronunciation. To a native speaker of the Korean language, the “G” sound of the KIYEOK consonant 302 is similar to the “K” sound of the KHIEUKH consonant 322. Likewise, the “D” sound of the TIKEUT consonant 306 is similar to the “T” sound of the THIEUTH consonant 324; the “B” sound of the PIEUP consonant 312 is similar to the “P” sound of the PHIEUPH consonant 326; and the “J” sound of the CIEUC consonant 318 is similar to the “CH” sound of the CHIEUCH consonant 320. Accordingly, it is preferable to match an aspiration consonant 320, 322, 324, 326 with its corresponding (similar sounding) non-aspiration consonant 318, 302, 306, 312 on the same key of the user interface, so that the user interface is easy-to-use and intuitive to the user. Also, since numeric keypads have at least ten keys, namely one key for each number from 1 through 9 as well as the number 0, placement of the ten non-aspiration consonants 330 and ten vowels 420 on these keys is very convenient.

FIG. 5 illustrates a preferred keypad layout 500 of the data entry keys 128 shown in FIG. 1. The data entry keys 128 of the preferred embodiment 100 include ten numeric keys, namely keys “1” through “9” and “0”, as well as a “*” key and a “#” key for a total of 12 keys. As stated above in reference to FIG. 1, the data entry keys 128 are also used to input individual Jamos symbols and as well as numbers. Preferably, the keys of the data entry keys 128 have Jamos symbols shown to the right of their corresponding numbers. However, it is to be understood that the positioning of the Jamos symbols on the keys is not important so long as a user may easily identify each Jamos symbol and, preferably, be able to distinguish the consonants from the vowels. Accordingly, each key is used to input either a number or a Jamos symbol.

For the preferred keypad layout 500 of FIG. 5, the user interface includes ten keys arranged in an ordered array, namely keys “1” through “9” and key “0”. For purposes of this preferred keypad layout 500, key “*” and key “#” are not considered to be a part of the user interface of a keypad entry system. Each key of the user interface is associated with at least one phonetic consonant and one phonetic vowel. In particular:

key “1” is associated with KIYEOK 302, A 402 and KHIEUKH 322;

key “2” is associated with NIEUN 304 and YA 404;

key “3” is associated with TIKEUT 306, EO 406 and THIEUTH 324;

key “4” is associated with RIEUL 308 and YEO 408;

key “5” is associated with MIEUM 310 and O 410;

key “6” is associated with PIEUP 312, YO 412 and PHIEUPH 326;

key “7” is associated with SIOS 314 and U 414;

key “8” is associated with IEUNG 316 and YU 416;

key “9” is associated with CIEUC 318, EU 418 and CHIEUCH 320; and

key “10” is associated with HIEUH 328 and I 420.

All ten keys have one vowel of the simple Jamos symbols, and one non-aspiration consonant of the simple Jamos symbols. Keys “1”, “3”, “6” and “9” further include an aspiration consonant 320, 322, 324, 326 that matches with its corresponding non-aspiration consonant 318, 302, 306, 312. Therefore, the 24 simple Jamos symbols are evenly distributed among the keys of the user interface of a keypad entry system. Also, regarding the four keys that have more than one consonant, the similar sounding consonants are matched together so that the user may easily find the appropriate key based on consonant's pronunciation. In addition, as shown in FIG. 5, the non-aspiration consonants 302-318, 328 and the vowels 402-420 are provided on the preferred keypad layout in alphabetical order (Jamos symbol order as shown in FIGS. 3 and 4) relative to the ordered array, namely keys “1” through “9” and key “0”.

An important characteristic of the preferred keypad layout (and the first alternative keypad layout described below) is for each key to have at least one consonant and at least one vowel. Korean Jamos symbols are combined to form Korean Hangul characters, and the typical structures of Korean Hangul characters are consonant-vowel and consonant-vowel-consonant. When selecting a key having one consonant and one vowel, the keypad entry system will identify the consonant for the first selection of the key and the vowel for the second selection of the key for each Hangul character entry. When selecting a key having two consonants and one vowel, the keypad entry system will identify one of the two consonants for the first selection of the key and the vowel for the second selection of the key for each Hangul character entry. Predictive text entry may be used to select between the two consonants as well as any selection of a key having more than one consonant and/or vowel. Thus, for the preferred keypad layout 500 described above, all ten keys will easily identify the vowel desired by the user and six keys of those ten keys will easily identify the consonant desired by the user. The remaining four keys having more than one consonant will determine the consonant desired by the user by using predictive text entry to select among the consonants.

FIG. 6 illustrates a first alternative keypad layout 600 of the data entry keys 128 shown in FIG. 1. The first alternative keypad layout 600 is similar to the preferred keypad layout 500 shown in FIG. 5, but includes the 33 extended Jamos symbols. In particular, the first alternative keypad layout 600 includes five double consonants 602, 204, 606, 608, 610 and four double vowels 612, 614, 616, 618. The double consonants 602, 604, 606, 608, 610 are matched with their respective single consonants 302, 306, 312, 314, 318 so that each matching pair is on the same key. Likewise, the double vowels 612, 614, 616, 618 are matched with their respective single vowels 402, 404, 406, 408 so that each matching pair is on the same key. Although the first alternative keypad layout 600 shown in FIG. 6 provides the five double consonants 602, 204, 606, 608, 610 and four double vowels 612, 614, 616, 618, the layout may be restricted to one or the other along with the twenty-four simple Jamos symbols. In other words, the first alternative keypad layout 600 may have the twenty-four simple Jamos symbols with the five double consonants 602, 204, 606, 608, 610 or the twenty-four simple Jamos symbols with the four double vowels 612, 614, 616, 618.

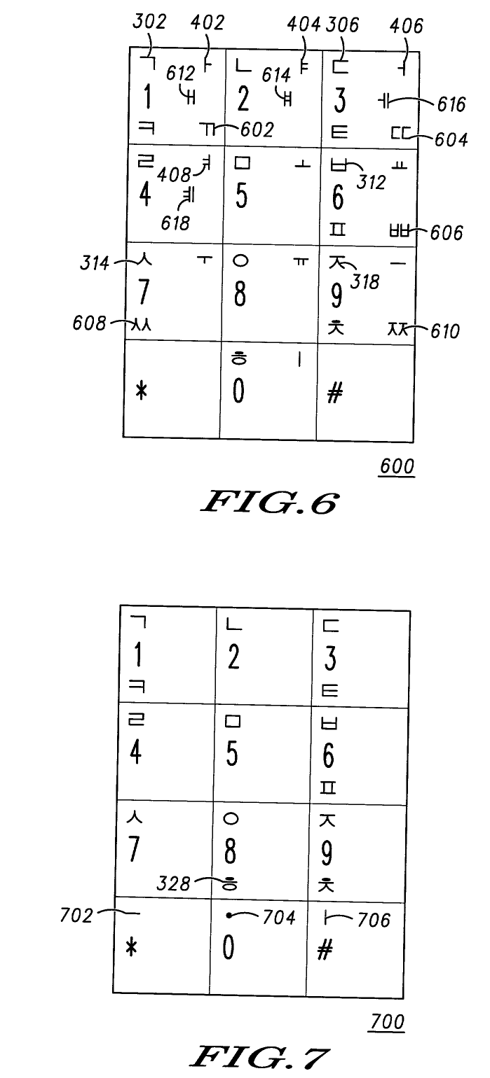

FIG. 7 illustrates a second alternative keypad layout 700 of the data entry keys 128 shown in FIG. 1. This second alternative keypad layout 700 is similar to the preferred keypad layout 500 shown in FIG. 5, but replaces the ten vowels of the simple Jamos symbols with the three primitive vowels, namely the symbols of the sky-people-land decomposition 702, 704, 706. As shown in FIG. 7, the fourteen consonants of the simple Jamos symbols 302, 304, 306, 308, 310, 312, 314, 316, 318, 320, 322, 324, 326, 328 are distributed among keys “1” through “9”, and the three symbols of the sky-people-land decomposition 702, 704, 706 correspond to key “*”, key “0” and key “#”. These three symbols of the sky-people-land decomposition 702, 704, 706 may be used to enter the twenty-one most commonly used vowels of the Jamos symbols. Also, in contrast to the preferred keypad layout 500 and the first alternative keypad layout 600, HIEUH 328 of the second alternative keypad layout 700 corresponds to key “8” instead of key “0” for convenient operation of the three symbols of the sky-people-land decomposition 702, 704, 706. This second alternative keypad layout benefits from non-aspiration consonant and aspiration consonant arrangement described above.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A user interface of a keypad entry system for a portable electronic device, the user interface comprising at least ten keys arranged in an ordered array, each key being associated with a phonetic consonant and a phonetic vowel.

2. The user interface of claim 1, wherein each key is associated with one of the following numeric digits: 1, 2, 3, 4, 5, 6, 7, 8, 9 and 0.

3. The user interface of claim 1, wherein each key is associated with one of the following phonetic vowels: A, YA, EO, YEO, O, YO, U, YU, EU and I.

4. The user interface of claim 1, wherein each key is associated with a non-aspiration consonant.

5. The user interface of claim 4, wherein each key is associated with one of the following non-aspiration consonants: KIYEOK, NIEUN, TIKEUT, RIEUL, MIEUM, PIEUP, SIOS, IEUNG, CIEUC and HIEUH.

6. The user interface of claim 1, wherein four keys of the keypad have at least two phonetic consonants.

7. The user interface of claim 6, wherein each of the four keys is associated with a non-aspiration consonant and an aspiration consonant, the non-aspiration and aspiration consonants being grouped based on similarity in pronunciation.

8. The user interface of claim 7, wherein:
each key is associated with one of the following non-aspiration consonants: KIYEOK, NIEUN, TIKEUT, RIEUL, MIEUM, PIEUP, SIOS, IEUNG, CIEUC and HIEUH; and
each of the four keys is associated with one of the following aspiration consonants: KHIEUKH, THIEUTH, PHIEUPH and CHIEUCH.

9. The user interface of claim 8, wherein:
a first key of the four keys is associated with the KIYEOK consonant and the KHIEUKH consonant;
a second key of the four keys is associated with the TIKEUT consonant and the THIEUTH consonant;
a third key of the four keys is associated with the PIEUP consonant and the PHIEUPH consonant; and
a fourth key of the four keys is associated with the CIEUC consonant and the CHIEUCH consonant;

10. The user interface of claim 1, wherein the phonetic consonants and vowels are Korean Jamos symbols used to generate Korean Hangul characters.

11. The user interface of claim 1, wherein at least one of the at least ten keys includes a double consonant on the same key as its respective single consonant.

12. The user interface of claim 1, wherein at least one of the at least ten keys includes a double vowel on the same key as its respective single vowel.

13. A user interface of a keypad entry system for Korean text entry, the user interface comprising:
a first key associated with the KIYEOK consonant and the KHIEUKH consonant;
a second key associated with the TIKEUT consonant and the THIEUTH consonant;
a third key associated with the PIEUP consonant and the PHIEUPH consonant; and
a fourth key associated with the CIEUC consonant and the CHIEUCH consonant.

14. The user interface of claim 13, further comprising six keys individually associated with each of the following phonetic consonants, respectively: NIEUN, RIEUL, MIEUM, SIOS, IEUNG and HIEUH.

15. The user interface of claim 13, further comprising fifth, sixth and seventh keys individually associated with three phonetic primitives of the sky-people-land decomposition, respectively.

16. A portable communication device comprising:
a plurality of keys arranged in an ordered array, each key being associated with a phonetic consonant and a phonetic vowel;
a controller coupled to the plurality of keys, the controller being capable of detecting a first selection of the plurality of keys and associating the first selection to a particular phonetic consonant of the selected key, the controller also being capable of detecting a second selection of the plurality of keys and associating the second selection to a particular phonetic vowel, the second selection being subsequent to the first selection; and
a display coupled to the controller, the display being capable of displaying the particular phonetic consonant and the particular phonetic vowel.
